(19) United States
(12) Patent Application Publication
(10) Pub. No.: US 2004/0153794 A1
(43) Pub. Date: Aug. 5, 2004

(54) Method for error injection by interruptions

(76) Inventors: Raoul Velazco, Grenoble (FR); Sana Rezgui, Grenoble (FR)

Correspondence Address: Robert A Skrivanek Jr, Lowrie Lando & Anastasi, One Main Street, Cambridge, MA, 02142, US

(21) Appl. No.: 10/466,597

(22) PCT Filed: Jan. 16, 2002
(86) PCT No.: PCT/FR02/00167

(30) Foreign Application Priority Data
Jan. 16, 2001 (FR) 01/00518

(51) Int. Cl. H04B 1/74

(52) U.S. Cl. 714/27

(57) ABSTRACT

The invention concerns a method for bit error injection into an equipment operating under the control of a given main programme, which consists in carrying out an interruption and introducing the bit error during the development of the interruption programme, wherein, when the error has to be injected into a target memory word stored at a site not directly accessible, the interruption programme comprises the following steps which consists in: placing in the stack (303) the content of a register (ACC), transferring (304) into the register (ACC) the content of the memory word, modifying (305) in the register (ACC) the repeated content of the target memory word to inject therein the selected error, transferring (306) the modified target memory word to its original site, unstacking (307) the register (ACC), and ending (308, 309) the interruption programme and returning to the main programme address indicated by the programme counter (PC).

### BACKGROUND OF THE INVENTION

1. Field of the Invention

The present invention generally relates to the testing of the capability of integrated circuit based electronic and logic systems, for example, systems intended for space applications, to operate properly under irradiation. However, given the miniaturization of integrated circuits, said circuits become more and more sensitive to radiation effects and the present invention also finds applications in the testing of integrated circuits used on ground.

The present invention more specifically aims at the verification of systems capable of executing a set of instructions or orders (microprocessor, microcontroller, signal processor, etc.).

2. Discussion of the Related Art

A conventional way of testing such systems is to place them in an irradiated environment, caused for example by a particle accelerator, and to verify their operation, taking into account the number of impacts that they receive. It can be conceived that such verifications are very heavy duty, especially considering the fact that they must be performed “on line”, that is, the tested circuit must accomplish the functions for which it has been designed for the considered application during the exposure to particles. Further, when they are performed on processors by means of so-called static strategies, these methods sometimes provide results which are very far from reality. Indeed, an impact on an integrated circuit, even if it causes a state switching of the content of a memory cell, may have in practice no influence upon the operation of a program running on this circuit.

Thus, the present invention aims at a method of bit error injection at any location of an integrated circuit while a main program is executed on this circuit.

More specifically still, the present invention aims at a method in which the fictive error injection is performed via an interrupt program.

Such a method has for example been provided in article “Transient Bitflip Injection in Microprocessor Embedded Applications” by R. Velazco and S. Rezgui, published in Proceedings of the 6^{th} IEEE International On-Line Testing Workshop, Jul. 3-5 2000, Palma de Mallorca, pp. 80-84.

In other words, the present invention relates to a digital architecture organized around a processor capable of executing a sequence of instructions or orders stored in a memory (external or internal) and of taking into account the effect of asynchronous input signals such as interrupts. The processor may be programmed to directly or indirectly perform read and write operations in each of the locations of the external memory, as well as of internal memory registers and areas.

Single bit upsets, or event upsets, currently designated as SEU (Single Event Upsets), may be caused in processors as a consequence of the execution of an adequate code which will essentially depend on certain features of the target. This code will here be called a CEU (Code Emulating an Upset). Similarly, the memory location disturbed by the execution of the CEU code will be called the CEU target. The upsets resulting from the execution of the CEU code will also be called CEUs (Code Emulated Upsets).

As a response to the activation of an interrupt, a processor will typically perform the steps of:

stopping the execution of the ongoing program after having completed the execution of the current instruction,

saving the context (at least the return value of the program counter PC in a stack),

branching towards the interrupt processing program causing the inversion of the selected target bit(s),

restoring the context from the stack to continue the execution of the interrupted program.

It is thus enough to activate the interrupt at different times of the execution of a program to cause the injection of bit upsets by software means.

In practice, the error injection by means of an interrupt program is performed relatively easily in the case where the target is a register or a memory word directly accessible by the interrupt program. However, practical difficulties to implement the method appear when the target is either a register or a memory word which is not directly accessible, or the register storing the program counter, or else the register storing the pointer of the stack in which is stored the context of the main program at the interrupt time.

Thus, the present invention aims at having access to all the memory areas of a processor which are accessible via the instruction set of any program associated with this processor. For example, in the case of Intel processor 8051, the accessible memory areas especially comprise the input/output accesses, the accumulators, the special registers, the program counter register, and the internal RAM. Only a very small number of memory areas of a processor remain inaccessible to the introduction of a CEU. Such areas especially comprise the input registers of the arithmetic and logic unit, memory latches, address registers, and the cache memory. A calculation performed in the case of a microprocessor 8051 and which can extend to many types of microprocessors shows that these non-accessible areas amount to less than 7% of all the memory areas of the processor.

Due to the efficiency of the error injection according to the present invention, it becomes possible to evaluate a real error rate for a given processor associated with a given program. This real error rate or system sensitivity can be evaluated by calculation. First, for a given processor submitted to a particle bombarding, a number P such that a single particle out of P is likely to cause a bit error (a CEU) can be determined. The present invention enables showing that out of N SEUs, n only are likely to disturb a given program running on a given processor. Thus, the system sensitivity may be estimated as being equal to n/NP. Once the exactness of the determination mode of the real error rate obtained has been validated by submitting a device to which the error determination method of the present invention has been applied to real conditions, for example, of work in space, the method can be applied to a system formed of the same hardware element, on which runs another software. It will then be sure that the method according to the present invention provides a correct result and it will not be necessary to carry out a new validation in real or simulated disturbed conditions, since P is constant for a given hardware and a given particle type.

It should also be noted that the method for analyzing the sensitivity of a system to CEU-type disturbances may be carried out in totally random fashion or systematically. A systematic analysis may especially be carried out for a given program on the successive steps of this program. Some phases of the program then generally appear to be little sensitive to CEUs while others are much more so. Sensitivity windows can thus be defined for each program. This may be useful in systems providing redundancies to only perform redundant operations on particularly sensitive portions of a given program.

### Summary of the Invention

To achieve these objects, the present invention provides a method for injecting bit errors into hardware operating under control of a given main program, consisting of performing an interrupt and of introducing the bit error during the progress of the interrupt program, in which, at the time of the interrupt, the return value of the program counter register and possibly the content of other registers such as state indicator registers, are memorized in a stack under control of a stack pointer.

When the error must be injected into a target memory word stored at a non-directly accessible location, the interrupt program comprises the steps of:

pushing into the stack the content of a register,

transferring into the register the content of the target memory word,

modifying in the register the copied content of the target memory word to inject the selected error therein,

transferring the modified target memory word to its original location,

popping the register, and

ending the interrupt program and returning to the address of the main program indicated by the program counter.

When the error must be injected into the program counter register, the interrupt program comprises the steps of:

pushing into the stack the content of a first register,

pushing into the stack the content of an accumulator,

transferring the value of the stack pointer register (corresponding to the address in the stack of the program counter return address) into the first register,

transferring the content of the program counter register such as indicated by the first register into the accumulator,

modifying the value of the program counter in the accumulator to inject the selected error therein,

reloading the modified value of the program counter into the stack at the address contained in the first register,

popping the accumulator, and

popping the first register.

When the error must be injected into a stack pointer register, the interrupt program comprises the steps of:

writing at a determined address a code of unconditional jump towards a determined memory cell,

pointing by means of the stack pointer towards the return value of the program counter,

transferring the content of the stack pointer into a first register,

transferring the return address of the program counter stored in the stack into a second register,

transferring the content of the second register after said unconditional jump code,

modifying the first register to inject the selected error into the stack pointer register,

executing an unconditional jump towards said determined address of the first-mentioned unconditional jump to obtain the return value of the main program.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1 is a symbolic representation of elements of a hardware/software system to which the present invention applies; and

FIGS. 2 to 5 show examples of sequences of an interrupt program respectively applicable to a directly-accessible register, to an indirect-access register, to the program counter, and to the stack pointer.

### DETAILED DESCRIPTION

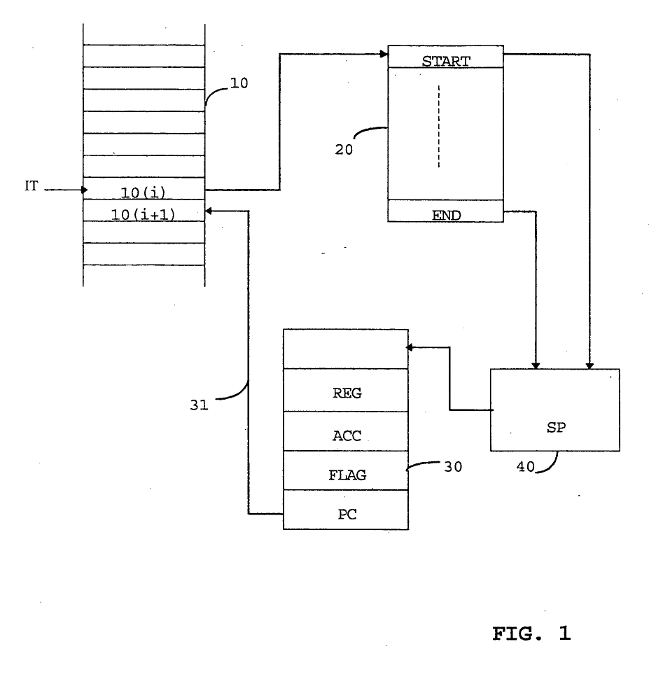

FIG. 1 shows in symbolic form elements of a hardware/software system. A main program 10 that can be considered either from a logic point of view as a succession of instructions, or from a hardware point of view as a memory containing the instructions, has been shown. The system also comprises one or several interrupt programs 20 and a stack 30 as well as a stack pointer 40.

In a conventional computer architecture, when an interrupt order is sent at a step 10(i) of a main program 10, several operations are performed:

the execution of ongoing instruction 10(i) is completed;

the program context, that is, essentially, the value of program counter PC corresponding to the return address (10(i+1)) of the main program, and possibly the content of various state indicator registers (flag) and other key parameters of the system, is saved; this context saving is conventionally performed in a stack 30 of first-in/first-out type under control of a stack pointer register (SP) 40;

it is proceeded to the first step (START) of interrupt program 20.

This has been symbolically shown in FIG. 1, indicating that an interrupt IT is likely to occur at step 10(i), that it is then proceeded to phase START of interrupt program 20, that this phase START controls stack pointer 40 which points towards stack 30 (conventionally, it is considered that stack pointer SP points to the last free cell in the stack).

Once these initial operations have been performed, the interrupt program unwinds to reach its final phase END. At this time, it gives an order to the stack pointer to pop the stack content, that is, all the information relative to the context which have been memorized at the interrupt are reset in their original locations. At the last step of this popping, the program counter content which corresponds to address i+1 of the main program is reached and the program is resumed at step 10(i+1), as symbolized by link 31.

As reminded previously, the object of the present invention is to introduce simple or multiple bit errors (SEUs) based on generic CEU codes at any selected location of the system at a selected step of the main program.

1. Error Injection into a Direct-Access Register

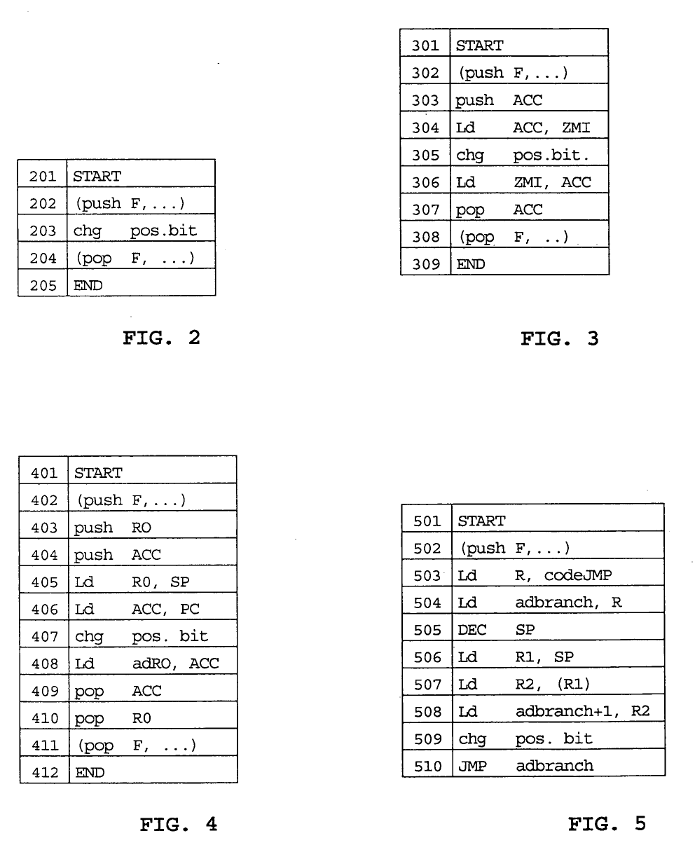

An example of an interrupt program intended to enable error injection into a directly-accessible register or memory word is very symbolically illustrated in FIG. 2.

At a first initialization step 201 (START), the address contained in the program counter or more specifically the return address [10(i+1)] of the program counter is transferred into stack 30.

At an optional step 202, state indicators (flags or F) and possibly other key registers are transferred (pushed) into stack 30, if not already provided by the normal interrupt program of the concerned system.

At step 203, the changing (chg) of one or several bit positions (pos.bit) is performed in a directly-accessible memory word.

Step 204 is an optional step which is carried out if step 202 has been performed, that is, the context elements of the computer which have been stacked at step 202 at the interrupt time are popped.

An interrupt program conventionally ends with a final step 205 which sends back to the continuation of the execution of the interrupted program.

It should be noted that the program of FIG. 2 is particularly simple to implement and that, conventionally, it requires a single instruction for the position change of a bit in the target. This change is performed in practice at the level of the concerned register by an XOR operation between the content of the concerned register and a mask contained in the CEU code.

2. Error Injection into an Indirect-Access Register

An example of an interrupt program intended to enable error injection into a non-directly accessible register or memory word is illustrated in FIG. 3.

Initial steps 301 and 302 are identical to steps 201 and 202 described in relation with FIG. 2.

At step 303, the program pushes into the stack the content of a register or accumulator ACC.

At step 304, the content of the target internal memory area (ZMI) is loaded (Ld) into register ACC.

At step 305, the desired modification of the target memory word is performed. This modification is now performed in register ACC which is accessible, similarly to the modification described in relation with step 203 of FIG. 2.

At step 306, the modified content of register ACC is sent back onto the memory area in which the target word was located.

Then, a popping step 307 complementary to stacking step 302 is performed to put back into accumulator ACC its original value before execution of the above-mentioned operations.

The program ends with steps 308 and 309 respectively similar to steps 204 and 205 described in relation with FIG. 2.

3. Error Injection into the Program Counter (PC)

An interrupt program enabling error injection into the program counter is illustrated in FIG. 4.

In this case, a particular difficulty is due to the fact that the program counter controls the sequencing of the execution steps of a program and that, when it is disturbed, it becomes difficult to properly execute the program.

A program of error injection into the content of the program counter according to the embodiment of the present invention starts with steps 401 and 402 similar to steps 201 and 202 described in relation with FIG. 2.

At step 403, the content of a first register R0 is pushed into the stack.

At step 404, the content of a second register ACC, currently called an accumulator, is also incorporated in the stack.

At step 405, the content of stack pointer SP which corresponds to the address in the stack of the return address of the program counter is transferred into register R0.

At step 406, the content (CP) of the program counter register such as indicated by first register R0 is transferred into accumulator ACC.

Only at step 407 is the selected error injection then performed on the content of register ACC, that is, the value of the program counter.

At step 408, the content of register ACC is transferred back into the stack at the address indicated by register R0.

The operations are then over and, successively, the accumulator is popped at step 409, register R0 is popped at step 410, and the final steps similar to steps 204 and 205 are carried out at steps 411 and 412.

4. Error Injection into the Stack Pointer (SP)

An interrupt program enabling error injection into the stack pointer is illustrated in FIG. 5.

The injection of an error into the stack pointer poses a specific problem because, if the stack pointer is disturbed during the interrupt program, the unwinding of the interrupted program can a priori not be resumed after execution of the interrupt program since the popping can no longer occur normally. Accordingly, the present invention provides a very specific method incorporating unconditional jump steps for the injection of an error into the stack pointer and the return to the interrupted program.

A program of error injection into the stack pointer content according to an embodiment of the present invention starts with steps 501 and 502 similar to steps 201 and 202 described in relation with FIG. 2.

At step 503-504, a code (JMP) of unconditional jump to a determined memory cell is written at a determined address (adbranch). This operation is generally performed via a register R.

At step 505, it is pointed (DEC) by means of the stack pointer to the program counter return value.

At step 506, the content of the stack pointer (the address in the stack of the return address of the program counter) is transferred into a first register R1.

At step 507, the return address of the program counter stored in the stack is transferred into a second register R2.

At step 508, the content of the second register is transferred to the address (adbranch+1) which follows the address (adbranch) at which said unconditional jump code has been written, to set the address (that which contains the program counter return value) to which the unconditional jump will send.

At step 509, first register R1 is modified to inject the selected error into the stack pointer register.

At step 510, a first unconditional jump towards the address (adbranch) at which said unconditional jump code has been written is executed and this unconditional jump is executed to reach the return value of the main program.

It should be noted that the program does not end with popping steps, which are no longer implementable since the stack pointer has been disturbed.

Generally, whatever the CEU target, it should be noted that, for most processors, the instruction sets necessary to the error injection according to the present invention enable performing these tasks in a few assembly language instructions only. These instructions, once compiled, will provide codes of a few tens of words at most. The critical aspect to simulate an SEU is the insertion of these codes into the ongoing program to have them executed at the desired time during execution of any program. For the injected error to faithfully reproduce SEUs occurring as a consequence of radiations, the execution of this code must have as a single effect the adulteration of the value of the SEU target, leaving unchanged the other memorization elements of the processor.

The present invention may be easily adapted by those skilled in the art of programming to specific hardware or software arrangements. Especially, if the size of the registers and other memory words intended to be transferred from one position to another is greater than the dimension of the cell, register, or stack towards which the transfer must be performed, the transfer may be decomposed into several elementary transfers, for example, by separating the most significant bits from the least significant bits.

Of course, the present invention is likely to have various alterations, modifications, and improvements which will readily occur to those skilled in the art. Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for injecting bit errors into hardware operating under control of a given main program, consisting of performing an interrupt and of introducing the bit error during the progress of the interrupt program, in which, at the time of the interrupt, the return value of the program counter register (PC) and possibly the content of other registers such as state indicator registers, are memorized in a stack under control of a stack pointer (SP), wherein, when the error must be injected into a target memory word stored at a non-directly accessible location, the interrupt program comprises the steps of:
pushing into the stack (303) the content of a register (ACC),
transferring (304) into the register (ACC) the content of the target memory word,
modifying (305) in the register (ACC) the copied content of the target memory word to inject the selected error therein,
transferring (306) the modified target memory word to its original location,
popping (307) the register (ACC), and
ending (308, 309) the interrupt program and returning to the address of the main program indicated by the program counter (PC).

2. The method of claim 1, wherein, when the error must be injected into the program counter register (PC), the interrupt program comprises the steps of:
pushing into the stack (403) the content of a first register (R0),
pushing into the stack (404) the content of an accumulator (ACC),
transferring (405) the value of the stack pointer register (SP) (corresponding to the address in the stack of the program counter return address) into the first register (R0),
transferring (406) the content of the program counter register (PC) such as indicated by the first register (R0) into the accumulator,
modifying (407) the value of the program counter in the accumulator (ACC) to inject the selected error therein,
reloading (408) the modified value of the program counter (PC) into the stack at the address contained in the first register (R0),
popping (409) the accumulator, and
popping (410) the first register.

3. The method of claim 1, wherein, when the error must be injected into a stack pointer register (SP), the interrupt program comprises the steps of:
writing (503-504) at a determined address (adbranch) a code (JMP) of unconditional jump towards a determined memory cell,
pointing (505) by means of the stack pointer towards the return value of the program counter (PC),
transferring (506) the content of the stack pointer (SP) into a first register (R1),
transferring (507) the return address of the program counter (PC) stored in the stack into a second register (R2),
transferring (508) the content of the second register (R2) after said unconditional jump code,
modifying (509) the first register (R1) to inject the selected error into the stack pointer register (SP),
executing (510) an unconditional jump towards said determined address of the first-mentioned unconditional jump to obtain the return value of the main program.
